(19) United States
(12) Patent Application Publication
(10) Pub. No.: US 2007/0145737 A1
(43) Pub. Date: Jun. 28, 2007

(54) Pipeline assembly with thermal shielding

(75) Inventor: Hein Diemer Benninga, Amsterdam (NL)

Correspondence Address: BROWDY AND NEIMARK, P.L.L.C.;624 NINTH STREET, NW, SUITE 300, WASHINGTON, DC, 20001-5303, US

(73) Assignee: HEEREMA MARINE CONTRACTORS NEDERLAND B.V., AA Leiden (NL)

(21) Appl. No.: 10/568,869

(22) PCT Filed: Aug. 20, 2004
(86) PCT No.: PCT/NL04/00588

§ 371 Date: Jan. 24, 2007

(30) Foreign Application Priority Data
Aug. 20, 2003 (NL) 1024141

(51) Int. Cl. F16L 59/16; F16L 7/00; F16L 13/02

(52) U.S. Cl. 285/123.3; 138/149; 285/47; 285/48; 285/123.1; 285/288.1; 285/294.1

(57) ABSTRACT

In a method for providing a pipeline assembly, having an inner pipeline and an outer pipeline, the outer pipeline is formed by welding outer pipe sections together. A thermal shielding is provided to protect the inner pipeline from the heat generated by the welding of the outer pipe sections. The thermal shielding had a low thermal conductivity and is heat resistant. The thermal shielding may have an annular form. The method may be used in laying a deep sea pipeline assembly and used in a J-lay method or S-lay method of laying pipes.

The present invention relates to a pipeline assembly having an outer pipeline and an inner pipeline. Pipeline assemblies with an outer pipeline and an inner pipeline are known in the art.

A problem in known devices is that damage may occur to the inner pipeline as a result of heat, caused by welding of abutting outer pipe sections of the outer pipeline. This damage may occur in the form of melting of the material of the inner pipeline, or local deformations of the inner pipeline. Other adverse effects on the inner pipeline resulting e.g. in a loss of strength or a shorter lifetime may also occur.

German patent application no. 3,741,083 discloses a pipeline assembly with an outer pipeline and an inner pipeline being spaced from each other, wherein the inner pipeline is covered with a thermal insulation layer. Spacer elements are used to fix the position of the inner pipeline relative to the position of the outer pipeline in the radial and axial direction thereof.

The thermal insulation layer is provided over the entire length of the inner pipeline and spaced from the outer pipeline, and has the function of thermally isolating the inner pipeline from its environment. In an area where the outer pipeline is welded, the thermal insulation layer is protected from the heat of the welding by a local thermal shielding which covers the thermal insulation layer on the inner pipeline. The thermal shielding may be manufactured from a ceramic material.

A problem with the known pipeline assembly is that the heat coming from the welding of the outer pipeline may disperse in the annular space between the inner pipeline and the outer pipeline in the axial direction of the pipeline assembly, away from the welding zone, and may damage or otherwise deteriorate the inner pipeline at a distance from the welding zone. This spreading of the welding heat may occur through the annular space between the inner pipeline and the outer pipeline. The thermal shielding does not prevent spreading of the heat in an axial direction.

Another problem of the known pipeline assembly is that the described thermal shielding is wound around the inner pipeline, which requires a substantial amount of labor and time.

It is an object of the invention to provide a pipeline assembly having an inner pipeline and an outer pipeline, wherein during construction the inner pipeline is not adversely affected by heat generated by the welding of abutting outer pipe sections to form the outer pipeline.

It is a further object of the invention to provide a fast and reliable method for constructing such a pipeline assembly.

According to the invention, at least one of these objects is attained by a pipeline assembly, comprising: an inner pipeline; a metal outer pipeline, comprising at least two outer pipe sections, which are welded to each other in an end-to-end relationship in an area of abutment thereof, the outer pipeline enclosing the inner pipeline; a thermal shielding positioned between the inner pipeline and the outer pipeline, the thermal shielding being configured to protect the inner pipeline from heat created by a welding operation in the area of abutment of the outer pipe sections, wherein the thermal shielding engages the outer pipeline.

This pipeline assembly has the advantage of protecting the inner pipeline against heat caused by the welding of the two outer pipe sections during construction thereof. The thermal shielding engages the outer pipeline in the area where it is necessary, thereby reducing a possible spreading of heat through the annular space between the outer pipeline and the inner pipeline in the axial direction of the pipeline, which heat might reach the inner pipeline at an axial distance away from the area of abutment, and might incur damage to the inner pipeline.

The inner pipeline may comprise inner pipe sections, which are joined in an end-to-end relationship.

In a preferred embodiment of the invention, the thermal shielding comprises a first region which has a low thermal conductivity, the first region being configured to prevent heat from the welding operation from reaching the inner pipeline. According to this embodiment, a good thermal insulation can be attained. The first region can be a part of the thermal shielding or comprise the whole thermal shielding.

In an advantageous embodiment according to the invention, the thermal shielding engages the inner pipeline. In this embodiment, the thermal shielding also forms a constructional element of the pipeline assembly, fixing the position of the inner pipeline in a radial direction relative to the position of the outer pipeline. In many applications of pipe-in-pipe-concepts, the inner pipeline must have a fixed radial position relative to the outer pipeline. Spacer members are often used to fix the radial position of the inner pipeline relative to the outer pipeline. These spacer members can have different shapes and sizes, but they have in common that they must be placed between the inner pipeline and the outer pipeline. This embodiment has the particular advantage of combining the function of the thermal shielding and the positioning function of the spacer members, thereby obviating the need for separate spacer members.

The thermal shielding may advantageously also fix the inner pipeline in an axial direction relative to the outer pipeline.

In a further preferred embodiment of the invention, the thermal shielding is heat resistant at least in the proximity of the area of abutment of the outer pipe sections. The welding causes high temperatures to arise close to the area wherein the welding is performed. According to this embodiment, the thermal shielding is capable of withstanding any damage thereto caused by the welding of the outer pipe sections.

In a further preferred embodiment of the invention, the thermal shielding engages the outer pipeline in the area of abutment of the outer pipe sections. This provides the advantage of directly shielding off the location where heat is generated during welding, and further reducing the amount of heat that spreads to the inner pipeline.

In a further preferred embodiment of the invention, the thermal shielding engages the outer pipeline in an area of engagement, wherein the area of engagement extends in the axial direction of the outer pipeline over a substantial distance on either side of the area of abutment of the outer pipe sections, at which distance there is substantially less heat during welding than in the area of abutment. Viewed in the axial direction of the pipeline, the thermal shielding may therefore engage the outer pipe section over a substantial length. In this way a full coverage of the area of the outer pipe sections which rises in temperature as a result of the welding operation is achieved.

This embodiment provides several advantages. First, if the thermal shielding itself rises in temperature due to the heat caused by the welding, it may transfer that heat to the outer pipeline at a location at which the outer pipeline itself is cooler than near the area in which the welding operation takes place, and hence the outer pipeline will be able to collect the heat from the thermal shielding. Also, this embodiment reduces the possibility of heat following a route which runs partially through the outer pipeline by means of heat conduction, and from there to the inner pipeline by means of heat radiation. This route is advantageously fenced off by this embodiment of the invention.

In a further preferred embodiment of the invention, the thermal shielding comprises a first region and a second region, wherein the second region has a high thermal conductivity, and wherein the second region engages the area of abutment of the outer pipe sections.

When the outer pipe sections are being welded, the heat originates from a welding zone, which can be regarded as a specific location. In addition to providing a first region with a low thermal conductivity, a transfer of heat to the inner pipeline is further reduced by means of a second region having a high thermal conductivity, which engages the welding zone. Due to its high thermal conductivity, the heat can spread through the second region, away from the welding zone in both an axial and a radial direction. The heat is transferred at least partially back to the outer pipeline by the second region, at a substantial distance from the welding zone, where the outer pipeline is substantially cooler than in the welding zone itself. This diversion of heat allows for faster and better welding of the outer pipeline.

The second region may be integrated with the first region into a single body. This provides the advantage of relatively easy handling of the thermal shielding.

In a further preferred embodiment of the invention, the thermal shielding comprises a third region, which is substantially positioned between the first region and the second region, and wherein the third region is at least partially filled with a thermally insulating substance. A very thorough thermal insulation may hereby be obtained. The third region may be a cavity defined by the first and second region, and filled with a substance or material which has a low or extremely low thermal conductivity, but provides no structural support.

In a further preferred embodiment of the invention, the thermal shielding has the form of a substantial annular body. An annular body is a natural and simple form for a thermal shielding under these conditions. The annular body may be positioned between the outer pipeline and the inner pipeline, near an area of abutment of two outer pipe sections. The annular body may have an outer diameter, which is equal to the inner diameter of the outer pipeline. The annular body may have an inner diameter which is equal to or slightly larger than the outer diameter of the inner pipeline. In this way, a proper fit can be achieved between the outer pipeline, the thermal shielding and the inner pipeline. The thermal shielding will envelop the circumference of the inner pipeline and protect the inner pipeline from heat in the area of abutment of two outer pipe sections.

Preferably, the first region has a substantially annular form. This is a simple and effective form for a region with a low thermal conductivity to shield the inner pipeline from the welding heat.

Preferably, the second region has a substantially annular form. An annular form can engage the outer pipeline on the inner circumference thereof substantially along the area of abutment of the outer pipe sections, thereby providing good contact with the area of abutment of the outer pipe sections. Thus, a simple and effective way of spreading the welding heat through the second region is provided. A further advantage is that the heat is also diverted back into the outer pipeline.

Preferably, the third region has a substantially annular form. If the first and second region are annular, then an annular third region can simply be positioned between the first and second region.

In a further preferred embodiment the third region is a void, preferably filled with air. A void can be filled with a gas having an extremely low thermal conductivity, providing the advantage of keeping the heat away from the inner pipeline effectively. Air is a cheap and effective gas with a low thermal conductivity. Other substances than air are also possible.

Alternatively, the third region is substantially manufactured from an insulating material, preferably cloth, the insulating material having a very low thermal conductivity. Insulating cloth is commercially available and is easily applicable. Microtherm is a commercially available product that may be applied. Of course, other products may also be applied.

In a further preferred embodiment of the invention, the thermal shielding comprises at least two segments which in combination form an annular body. If the thermal shielding comprises segments, it is easy to handle or install between the inner pipeline and the outer pipeline. The segments may be positioned independently. The thermal shielding can be placed in the correct position by moving the two segments towards one another in a radial direction relative to the pipe. In this way, a fast and easy installation of the thermal shielding around the inner pipeline is obtained. In practice, a different number than two segments may be used.

In a further preferred embodiment of the invention, the segments have substantially the same size. A same or uniform size of the segments further facilitates the manufacturing thereof, also facilitates the handling and installation thereof, because the segments can be put together in substantially the same way.

In a further preferred embodiment of the invention, the thermal shielding, in particular the first region, is at least in part manufactured from a ceramic material. Ceramic materials are known to be heat resistant, to have a low thermal conductivity, and to provide good structural characteristics.

It is also possible that the thermal shielding, in particular the first region, is at least in part manufactured from a synthetic material. A synthetic material such as Bakelite provides the low thermal conductivity that is required for shielding the heat from the inner pipeline. Other synthetic materials are also possible.

In a further preferred embodiment of the invention, the second region is manufactured from steel. Steel has a high thermal conductivity and is also resistant to heat. Further, it is a sturdy material, well suited to provide structural support to the welding puddle in the area of abutment of the outer pipe sections during welding thereof. If the thermal shielding is formed by a plurality of segments, the second region may also have the function of keeping the segments in a fixed position relative to one another. The second region may then comprise two or more segments, which are placed around the segments of thermal shielding, and then welded together.

It is also possible to provide the second region as a backing strip on the outer side of the segments of thermal shielding, wherein the backing strip is adapted to support a puddle of fluid welding material in an area of abutment of two outer pipe sections during welding. During the welding operation, the temperatures of the ends of the outer pipe sections can become very high.

In a further preferred embodiment, the second region is positioned substantially around the first region. If the first and second region have an annular form, the two regions (or parts), may be positioned concentrically, wherein the second region surrounds the first region. This configuration provides a simple and effective form for a thermal shielding.

In a further preferred embodiment of the invention, the thermal shielding extends over a length in the axial direction of the pipeline assembly, wherein said length is substantially smaller than the length of an outer pipe section. In this embodiment, the thermal shielding is provided only in the areas where it is needed, i.e. the area of abutment of two outer pipe sections. The material, which is used for the thermal shielding, may be a costly material, and the feature of this embodiment provides an economic use of the material that is used for the thermal shielding.

Also, a substantial part of the length of an outer pipe section, which is located outside the area of abutment, is then advantageously free of thermal shielding. This provides the possibility of applying the inner pipeline as a lining of the outer pipeline, as will be further explained hereinafter.

In a further preferred embodiment of the invention, the pipeline assembly further comprises first connection means for fixedly connecting the thermal shielding to the inner pipeline. In this embodiment, the thermal shielding advantageously holds the inner pipeline in a desired position relative to the outer pipeline in a radial and an axial direction of the inner pipeline. In pipe laying in deep water, for instance in J-lay mode, there may be a substantial length of inner pipeline positioned vertically inside an outer pipeline (possibly up to several thousand meters), both the inner and outer pipeline having a substantially vertical orientation. Without supports the inner pipeline would be running free inside the outer pipeline. This would result in buckling of the inner pipeline, which is undesirable. Fixing the thermal shielding to the inner pipeline advantageously prevents buckling of the inner pipeline.

In a further preferred embodiment of the invention, the pipeline assembly further comprises second connection means for fixedly connecting the thermal shielding to the outer pipeline. Advantageously, the thermal shielding holds the inner pipeline in the correct position relative to the outer pipeline in the radial and axial direction of the inner pipeline.

In a further preferred embodiment of the invention, the inner pipeline is at least in part manufactured from a material, chosen from a group, consisting of: a synthetic material and a composite metal/synthetic material. The invention is preferably used under circumstances in which the inner pipeline needs protection against heat. Many synthetic materials are known to be sensitive to heat. They can be damaged or degraded as a result of heat from a welding operation, for instance with respect to form, permeability, lifetime, yield properties or other characteristics. Therefore, the invention is specifically useful for these materials.

In a further preferred embodiment of the invention, the pipeline assembly comprises a plurality of joined pipe units, wherein a pipe unit comprises an outer pipe section, an inner pipe section and a thermal shielding, wherein the inner pipe section is arranged inside the outer pipe section, and wherein the thermal shielding is positioned between the inner pipe section and the outer pipe section, preferably proximal to one end of the outer pipe section. A pipeline assembly comprising pipe units can be assembled at high speed and therefore in a cost-efficient way.

It is also possible to have a part of thermal shielding on both ends of a pipe unit. In this case, when a first and a second pipe unit are joined, a first part of thermal shielding on one end of the first pipe unit will engage a second part of thermal shielding on a first end of the second pipe unit. Provisions must be made to ensure that the two parts of thermal shielding engage with each other properly and form a single body of thermal shielding.

The invention further relates to a pipe unit for use in a pipeline assembly.

In a preferred embodiment of the invention, the inner pipeline substantially engages the outer pipeline outside the region of the thermal shielding. In this way, the inner pipeline is a lining of the outer pipeline. Pipeline assemblies having an inner lining are widely used in the field of the art.

In a further preferred embodiment, the inner pipeline has an outer diameter, and the outer pipeline has an inner diameter, wherein the outer diameter of the inner pipeline is between 1 and 50 mm smaller than the inner diameter of the outer pipeline, preferably between 10 and 30 mm smaller. With these dimensions, the inner pipeline can easily be transformed into a lining and engages the outer pipeline very well after deformation.

In a further aspect, the thermal shielding has a substantial annular form, comprising a first end and a second end, wherein the thermal shielding has tapered first and second ends. The inner diameter of the thermal shielding is smaller than the inner diameter of the outer pipeline. This form of the thermal shielding provides a gradual transition for the inner pipeline from the inner diameter of the outer pipeline to the smaller inner diameter of the thermal shielding.

The invention further relates to a thermal shielding described above. A thermal shielding as described above can be manufactured independently of the inner and outer pipelines, and provides the same advantages when applied.

The invention further relates to a method for providing a pipeline assembly, comprising:

providing an inner pipeline by joining abutting inner pipe sections;

providing a metal outer pipeline enclosing the inner pipeline by welding abutting outer pipe sections to each other in an area of abutment thereof; and

providing a thermal shielding between the inner pipeline and the outer pipeline, wherein the thermal shielding is configured to protect the inner pipeline from heat created by the welding operation in the area of abutment of the outer pipe sections, wherein the thermal shielding engages the outer pipeline.

Such a pipeline assembly is cost-effective, reliable and has a long lifetime.

In a preferred embodiment of the present invention, the method comprises:

providing a first inner pipe section and a second inner pipe section, wherein the first inner pipe section defines the end of an inner pipeline;

providing a first outer pipe section and a second outer pipe section, wherein the first outer pipe section defines the end of an outer pipeline;

positioning the second inner pipe section in an abutting position relative to the first inner pipe section;

joining the first inner pipe section and the second inner pipe section;

providing the thermal shielding between the inner pipeline and the outer pipeline;

positioning the second outer pipe section in an abutting position relative to the first outer pipe section; and

welding the second outer pipe section to the first outer pipe section.

By performing these steps, pipeline assemblies having an inner pipeline, an outer pipeline and thermal shielding can be constructed in an economic and reliable way.

In a further preferred embodiment of the invention, an outer pipe section, an inner pipe section and a thermal shielding are pre-assembled into a pipe unit, in which pre-assembly the inner pipe section is arranged inside the outer pipe section, and wherein the thermal shielding is arranged between the inner pipe section and the outer pipe section, proximal to one end of the outer pipe section, and wherein a plurality of pipe units are assembled into a pipeline assembly.

The pre-assembly of pipe units may provide a higher speed of production of the pipeline assembly, thereby reducing costs of production. In some situations, it is inconvenient to carry out the assembly of an inner pipe section, a thermal shielding and an outer pipe section into a pipe unit, prior and/or separate from the assembly of these components to the pipeline assembly itself. The construction of the pipeline assembly is then simplified to an operation in which consecutive pipe units are connected to the pipeline assembly. This may increase the speed of production and improve the quality of the pipeline assembly. The pre-assembly may also save storage space onboard a vessel or obviate the need for certain equipment onboard a vessel, such as positioning means which can position both an inner pipe section and an outer pipe section.

In a preferred embodiment, the inner pipeline is deformed to substantially engage with the outer pipeline outside the region of the thermal shielding. The deformation of the inner pipeline may be permanent, causing the inner pipeline to permanently engage with the outer pipeline once the deformation has been completed. This method provides an economic and reliable way of lining steel pipes.

In a further preferred embodiment the pressure inside the inner pipeline is increased to a level which is higher than the pressure in the area between the inner pipeline and the outer pipeline. This provides the particular advantage of establishing a uniform deformation of the inner pipeline over the required length of the inner pipeline and over the entire circumference of the inner pipeline.

In one advantageous aspect, the invention relates to a method, wherein the pressure in the inner pipeline is increased by filling the inner pipeline with a pressurized fluid, preferably water. The inner pipeline may be filled up to, or close to, the end of the pipeline assembly. If the method is used for the laying of a deep-sea pipeline assembly, the pipeline assembly will be suspended from a pipe-laying vessel. The depth of the water in which the pipeline assembly is laid, may be substantial. In that case, filling the inner pipeline with water will create a hydrostatic pressure to be built up inside the inner pipeline, wherein the hydrostatic pressure increases with the depth relative to the water level inside the inner pipeline. At a certain depth, the hydrostatic pressure will be enough to deform the inner pipeline and cause the inner pipeline to contact the outer pipeline. This, in effect, is a very cost-effective and fast way of turning the inner pipeline into a lining of the outer pipeline. When the pipeline assembly is finished, measures can be taken to remove the water from the inner pipeline. If the method is performed for the laying of a pipeline assembly on land, the fluid must be pressurized by other means, such as a pump.

In a preferred embodiment of the invention, the pipeline assembly is laid at sea. The invention is especially suitable for deep-sea pipeline assemblies, which for instance are laid in a J-lay mode or an S-lay mode. In an operation involving the laying of a deep sea pipeline assembly, it is important that the pipeline assembly can be constructed at high speed, since the costs of the used equipment and the people who are involved in performing these operations offshore are very high per unit of time. This method enables a fast and reliable construction and is therefore ideally suited to operations at sea.

The claims and advantages will be more readily appreciated as the same becomes better understood by reference to the following detailed description and considered in connection with the accompanying drawings in which like reference symbols relate to the same parts or parts having the same function, and wherein:

FIG. 1 shows a cross-sectional view of a pipeline assembly in a first embodiment according to the invention;

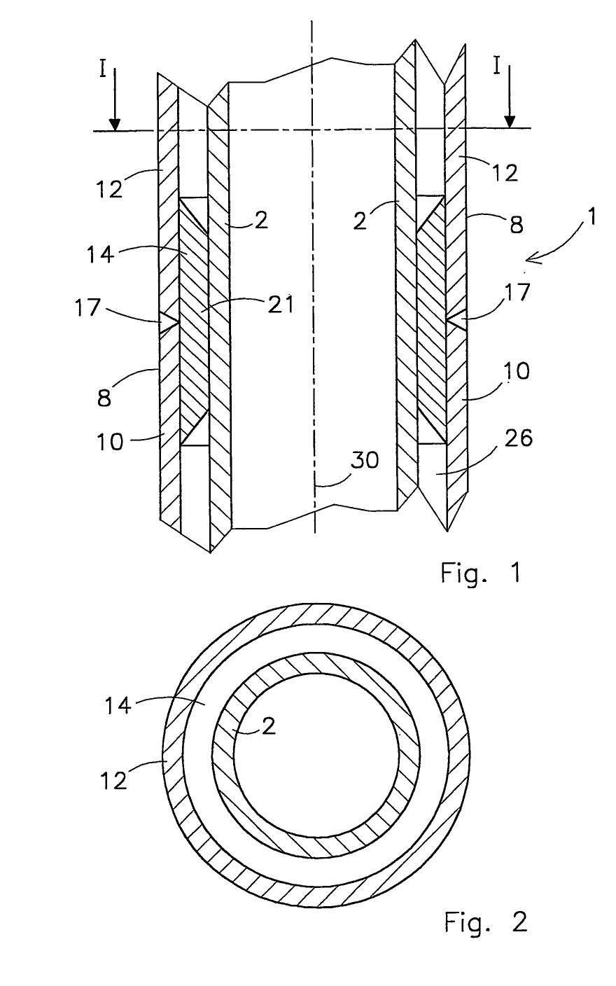

FIG. 2 shows a cross-sectional top view of the pipeline assembly in a first embodiment according to FIG. 1, taken along the line I-I in FIG. 1;

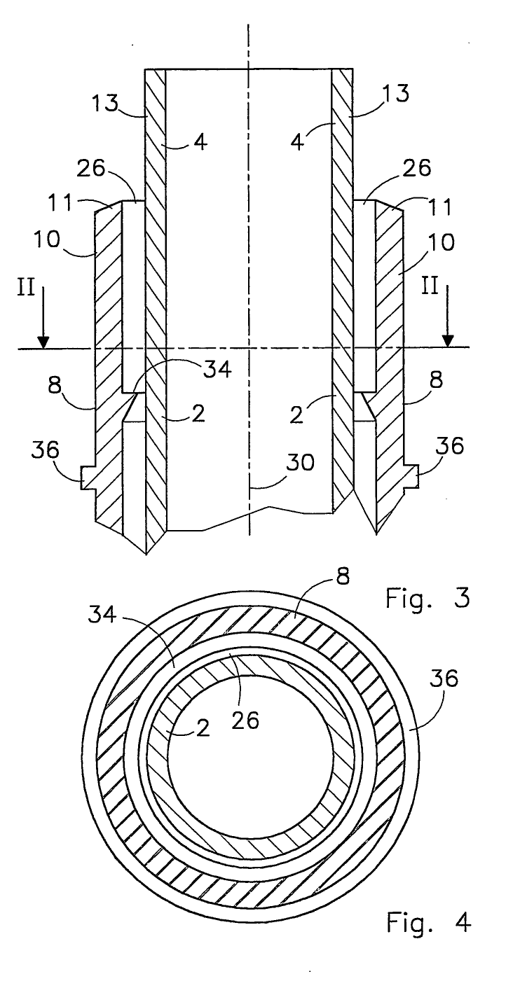

FIG. 3 shows a cross-sectional view of a pipeline assembly in a first stage of the method according to the invention;

FIG. 4 shows a cross-sectional top view of the pipeline assembly in a first stage of the method according to FIG. 3, taken along the line II-II in FIG. 3;

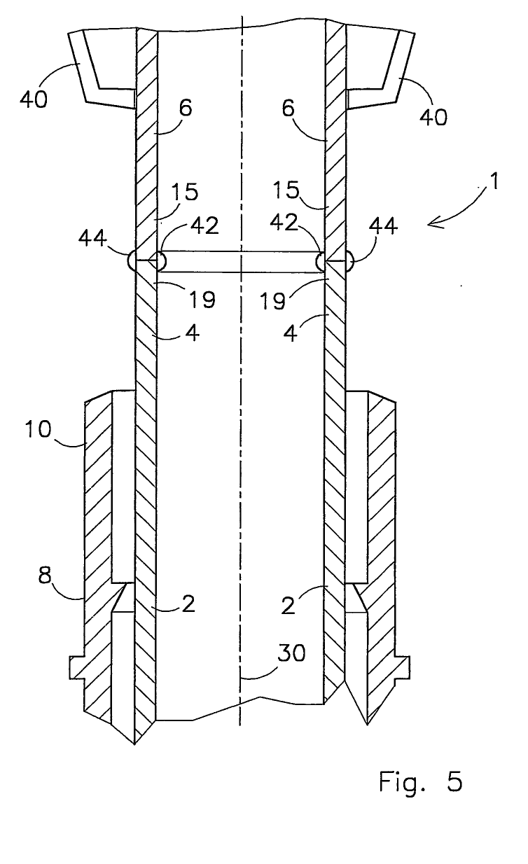

FIG. 5 shows a cross-sectional view of the pipeline assembly in a second stage of the method according to the invention;

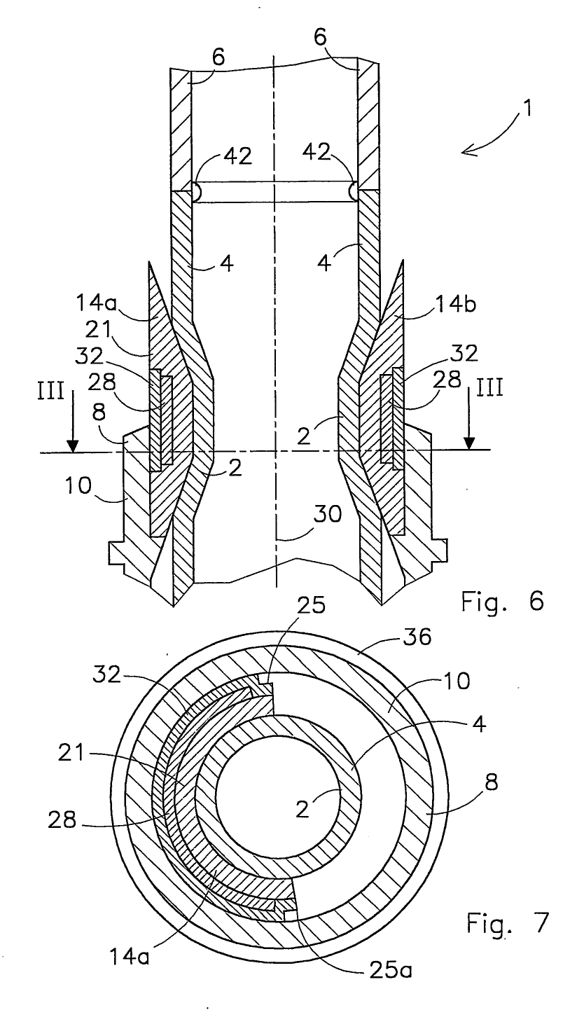

FIG. 6 shows a cross-sectional view of the pipeline assembly in a third stage of the method according to the invention;

FIG. 7 shows a cross-sectional top view of the pipeline assembly in the third stage of the method according to FIG. 6, taken along the line III-III in FIG. 6;

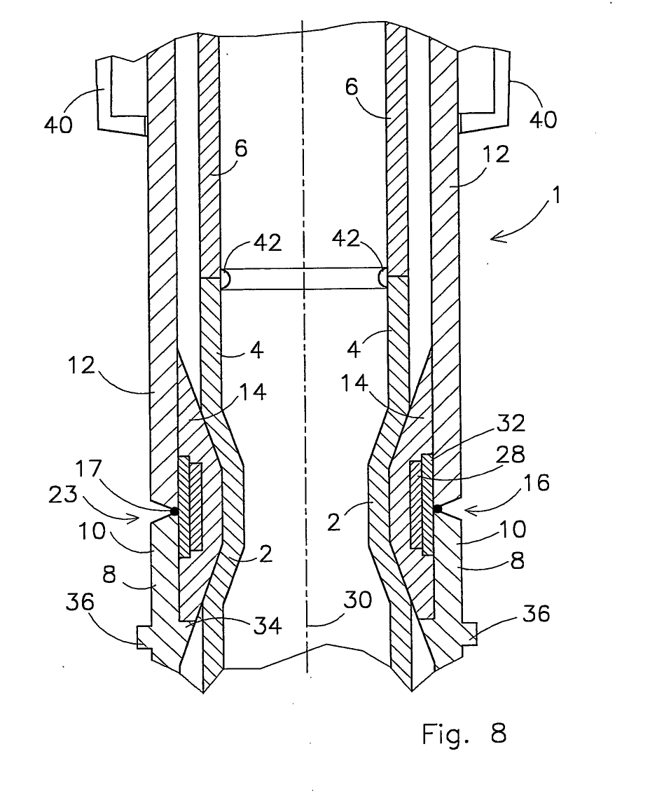

FIG. 8 shows a cross-sectional view of the pipeline assembly with a thermal shielding in a fourth stage of the method according to the invention;

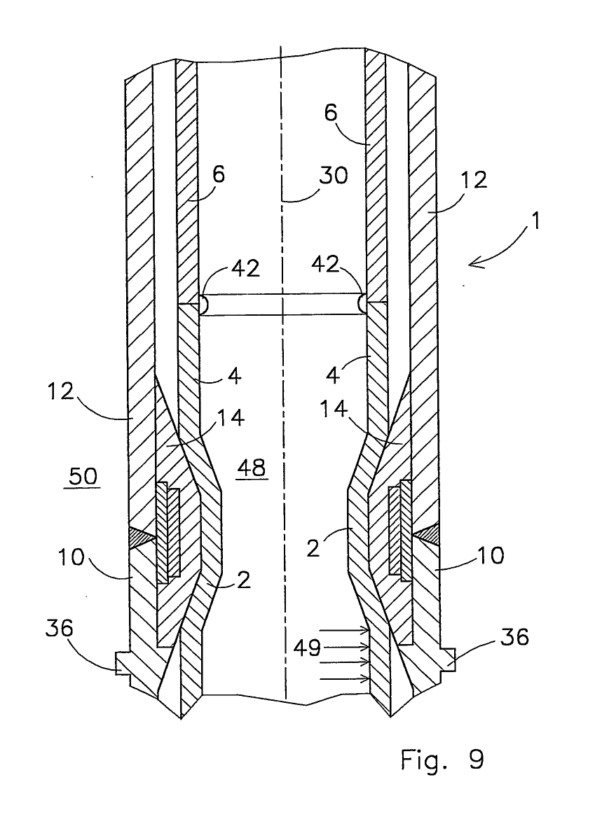

FIG. 9 shows a cross-sectional view of the pipeline assembly in a fifth stage according to the method of the invention;

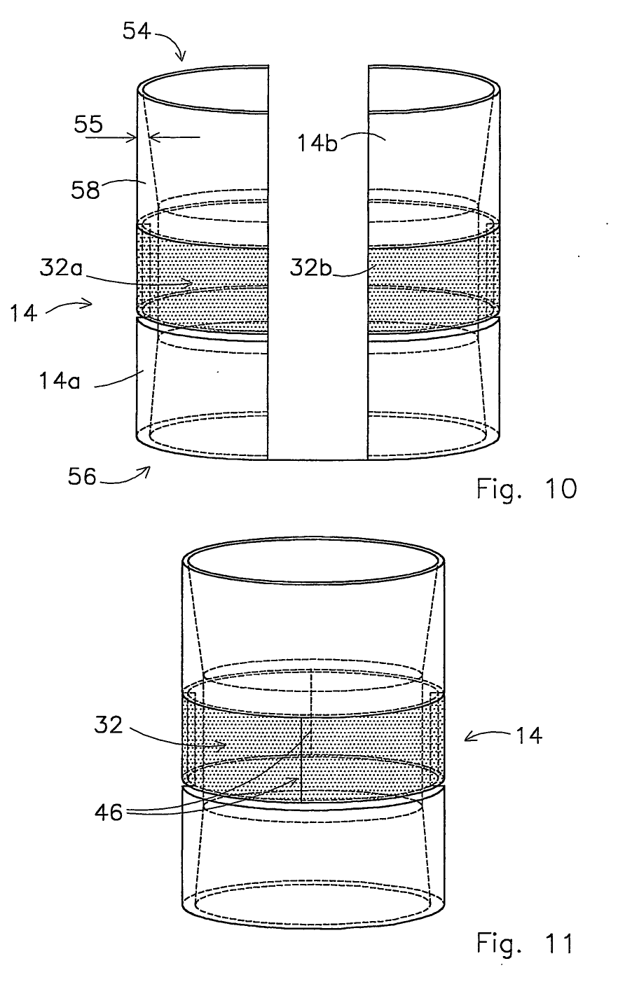

FIG. 10 shows a perspective exploded view of a thermal shielding according to the invention;

FIG. 11 shows a perspective view of another embodiment of the thermal shielding according to the invention; and

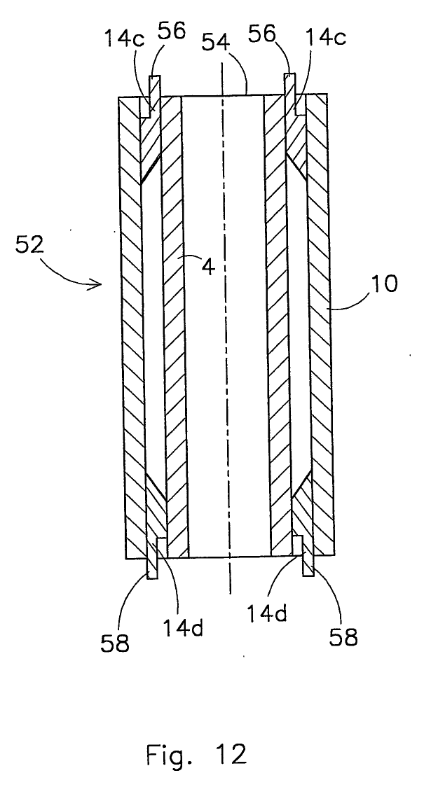

FIG. 12 shows a cross sectional view of a pipe unit.

According to FIG. 1, a pipeline assembly 1 comprises an inner pipeline 2 and an outer pipeline 8. An annular space 26 is present between the inner pipeline 2 and the outer pipeline 8. The pipeline assembly 1 has a center line 30, shown as a dash-dotted line in FIG. 1. The outer pipeline 8 comprises a first outer pipe section 10 and a second outer pipe section 12, which are welded together in a welding area 17. A thermal shielding 14 is provided between the inner pipeline 2 and the outer pipeline 8, in order to protect the inner pipeline 2 when the outer pipe sections 10, 12 are welded together. The thermal shielding 14 engages the inner pipeline 2 and engages the outer pipeline 10 near the welding area 17, thereby positioning the inner pipeline 2 in a fixed radial position relative to the outer pipeline 8. The thermal shielding 14 is composed of a single, first region 21 having a low thermal conductivity. The thermal shielding has an annular form and has a substantial length viewed in the axial direction of the pipeline. A substantial length assists in shielding welding heat which is conducted by the outer pipeline 8 in the axial direction of the outer pipeline 8.

The outer pipeline 8 is manufactured from a metal, preferably carbon steel. The inner pipeline 2 can be manufactured from a synthetic material, or a composite metal/synthetic material. The annular space that is formed between the inner pipeline and the outer pipeline can have a radial width of between 1 and 50 mm, preferably between 10 and 30 mm. FIG. 2 shows, starting from the center and proceeding outwardly, the inner pipeline 2, the thermal shielding 14, viewed from the top, and the outer pipeline 8.

According to FIG. 3, a first inner pipe section 4 forms a free end 13 of the inner pipeline 2 and a first outer pipe section 10 forms a free end 11 of the outer pipeline 8. A ridge 34 is provided on the inner side of the first outer pipe section 10 along at least part of its circumference. The ridge 34 is configured to form a connection means between the outer pipeline 8 and the thermal shielding 14. Similar connection means may be provided to connect the thermal shielding 14 to the inner pipeline 2.

The pipeline assembly 1 may e.g. be suspended from a vessel at sea, in particular from the bottom end of a J-lay tower (not shown). The pipeline assembly 1 may be supported by a hang-off collar 36. The pipeline assembly 1 may extend downwards to the bottom of a sea. Although in FIG. 3 the pipeline assembly 1 is shown in a vertical position, a person skilled in the art will readily appreciate that if the method according to the invention is to be used for the laying of a pipeline assembly 1 in an S-lay method from a vessel at sea, the pipeline assembly 1 will be laid in a substantially horizontal position. Also, the pipeline assembly 1 may be laid on land. In that case, the pipeline assembly 1 will also be laid in a substantially horizontal position.

FIG. 4 shows, starting from the center and proceeding outwardly, the inner pipeline 2, the annular space 26 between the inner pipeline 2 and the outer pipeline 8, the ridge 34, the outer pipeline 8 and the hang-off collar 36.

Following FIG. 3, FIG. 5 shows in a next stage a first inner pipe section 4 having an upper end defining the (temporary) end of the inner pipeline 2. A second inner pipe section 6 is held in a coaxial position with the first inner pipe section 4 by a clamp 40. The clamp 40 may be movable and operable by an operator (not shown) in order to position the second inner pipe section 6. The second inner pipe section 6 is moved downwards, until a lower end 15 of the second inner pipe section 6 abuts the upper end 19 of the first inner pipe section 4. The second inner pipe section 6 is joined to the first inner pipe section 4, thereby forming welding beads 42, 44.

Further to FIG. 5, FIGS. 6 and 7 show the pipeline assembly 1 with the welding bead 44 on the outside of the inner pipeline 2 removed.

First and second semi-annular segments 14a and 14b of the thermal shielding have been inserted between the inner pipeline 2 and the outer pipeline 8, thereby partly deforming a part of the inner pipeline 2 towards the central axis 30 thereof. The thermal shielding 14 is supported in the axial direction of the pipeline assembly 1 by the ridge 34. Additional connection means (not shown) may connect the thermal shielding 14 to the inner pipeline 2.

The thermal shielding 14 comprises a first region 21 having a low thermal conductivity. The thermal shielding also comprises a second region in the form of a backing strip 32 and a third region in the form of an insulation layer 28. The backing strip 32 is positioned on the outer side of the thermal shielding 14, and is adapted to engage with the inner side of the outer pipeline 8. The thermal shielding 14 is manufactured from a ceramic material. Ceramic material is heat resistant, has a low thermal conductivity and is sturdy.

The backing strip 32 is manufactured from steel. Steel is heat resistant, sturdy and has a high thermal conductivity, This aids in spreading the heat and conducting the heat back to the outer pipeline 8 in an area remote from the welding zone, where the outer pipeline is cool enough to collect the heat from the backing strip 32. Other heat resistant materials with a high thermal conductivity may also be applied.

Preferably, the insulation layer 28 is a cavity filled with air. Air has a low thermal conductivity and provides an excellent insulation against heat. Other substances or materials providing thermal insulation can also be applied.

The thermal shielding 14 is positioned in the region of a free end 11 of the first outer pipe section 10. A certain length of the inner pipeline 2 may be permanently deformed by the thermal shielding 14. It is also possible to use a separate deformation tool (not shown) to deform the inner pipeline 2 prior to the installation of the thermal shielding 14. After the first segment 14a of the thermal shielding 14 is placed in the correct position, a second segment 14b of the thermal shielding is positioned, thereby forming a thermal shielding 14 having an annular form. Each segment 14a, 14b comprises a respective backing strip 32 which are welded together to form the backing strip 32. Instead of two segments, also three or more segments may constitute the thermal shielding 14. Different segments may have different sizes.

FIG. 7 shows a first segment 14a of the thermal shielding in a cross sectional view along, positioned between the inner pipeline 2 and the outer pipeline 8. The first region 21, the second region 32 are shown, with the insulation layer 28 in between. The second segment 14b of the thermal shielding is not shown.

The segment 14a of the thermal shielding 14 has a coupling 25a which is constructed to engage with a corresponding coupling 25b (not shown) of the second segment 14b of the thermal shielding 14.

Following FIGS. 6 and 7, FIG. 8 shows in a next stage a second outer pipe section 12 being positioned coaxially with the first outer pipe section 10 and being lowered into an abutting position with the first outer pipe section 10. The lowering is performed with the controllable clamp 40. An area of abutment 16 of the outer pipe sections 10, 12 is thereby formed. A welding area 17 having a V-shape, U-shape or J-shape is formed between the two outer pipe sections 10, 12. The outer pipe sections 10, 12 can now be welded to one another, using a welding apparatus known in the art.

The thermal shielding 14 keeps the inner pipeline 2 in a fixed position relative to the outer pipeline 8 in the axial direction thereof. Also, the thermal shielding 14 supports the inner pipeline 2 in the radial direction relative to the outer pipeline 8. When the second outer pipe section 12 is welded to the first outer pipe section 10, the thermal shielding 14 protects the inner pipeline 2 from the heat generated by the welding operation. The backing strip 32 supports the welding puddle 23 between the first outer pipe section 10 and the second outer pipe section 12 in the area of abutment 16. The insulation layer 28 further reduces the spreading of heat generated by the welding towards the inner pipeline 2.

Following FIG. 8, FIG. 9 shows in a next stage the second outer pipe section 12 having been welded to the first outer pipe section 10. The pipeline assembly 1 may now be lowered in the water 50 from a vessel (not shown) to a seabed. During or after lowering, the inner pipeline 2 is gradually filled with water. This causes a hydrostatic pressure in the inner pipeline 2 to build up, which pressure is directed outwardly against the inner side of the inner pipeline, in the direction of arrows 49. Although the arrows are only shown for a small portion of the inner pipeline, a person skilled in the art will acknowledge that the water pressure will exist at every location on the inside of the inner pipeline 2 where there is water. Because the annular space 26 between the inner pipeline 2 and the outer pipeline 8 is under atmospheric pressure, the pressure on the inner pipeline 2 from the inside towards the outside will become higher than in the reverse direction. The hydrostatic pressure increases with the depth of the inner pipeline 2 relative to the water surface of the water in the inner pipeline 2. Beyond a certain depth, the hydrostatic pressure of the water in the inner pipeline 2 is high enough to deform the inner pipeline 2 towards the outer pipeline 8. This results in a substantial engagement of the inner pipeline 2 and the outer pipeline 8. The pressure of the water 48 may then permanently deform the inner pipeline 2, depending on the tensile stress limit of the material of the inner pipeline 2. The inner pipeline 2 may thus form a lining of the outer pipeline 8. If the method of providing a pipeline assembly described above is applied for pipeline assemblies on land, different methods of providing the pressure can be used, such as filling at least a part of the inner pipeline with a fluid, closing said part, and increasing the pressure of the fluid.

FIG. 10 shows a side view of two segments 14a, 14b of thermal shielding 14. The backing strip 32 is provided on the outside of the thermal shielding 14. When the two segments 14a, 14b are joined together, they form an annular form, having a first end 54 and a second end 56. The thermal shielding has a thickness, as indicated by arrow 55, and the thickness is smaller at the ends 54, 56 of the thermal shielding 14, compared to a central portion 58 of the thermal shielding 14. This varying thickness assists in guiding the inner pipeline 2 and providing a gradual deformation of the inner pipeline 2.

FIG. 11 shows the thermal shielding 14 after the two segments 14a, 14b have been joined together. The backing strips 32a, 32b are welded together at welding zones 46 to form a backing strip 32.

FIG. 12 shows a pipe unit 52 comprising an inner pipe section 4 and an outer pipe section 10. The pipe unit 52 is pre-assembled having a first part of thermal shielding 14c on a first end 54, and a second part of thermal shielding 14d on a second end of the pipe unit 52. A first part of thermal shielding 14c is adapted to engage a second part of thermal shielding on a second pipe unit (not shown) when two pipe units are joined together. The first part of thermal shielding 14c may comprise a coupling 56, which is adapted to engage a second coupling 58 of a second part of thermal shielding 14d on another pipe unit (not shown).

Thus, a pipeline assembly 1 comprising thermal shielding 14 can be manufactured very efficiently. The individual pipe units 52 can for instance be pre-assembled on shore, and the pipeline assembly 1 can be manufactured from the individual pipe units 52 on board a vessel at sea, thus forming a pipeline assembly 1 with an inner pipeline 2 and an outer pipeline 8. The inner pipeline 2 may be constructed to form a lining of the outer pipeline 8. The inner pipeline 2 may be formed as a lining of the outer pipeline 8 during the pre-assembly of the pipe unit 52, or during the assembling of the pipe units 52, for instance by applying a hydrostatic pressure inside the inner pipeline.

While the invention has been described and illustrated in its preferred embodiments, it should be understood that departures may be made therefrom within the scope of the invention, which is not limited to the details disclosed herein.

1. A pipeline assembly, comprising:
an inner pipeline;
a metal outer pipeline, comprising at least two outer pipe sections, which are welded to each other in an end-to-end relationship in an area of abutment thereof, the outer pipeline enclosing the inner pipeline;
a thermal shielding positioned between the inner pipeline and the outer pipeline, the thermal shielding being configured to protect the inner pipeline from heat created by a welding operation in the area of abutment of the outer pipe sections, wherein the thermal shielding engages the outer pipeline.

2. The pipeline assembly according to claim 1, wherein the thermal shielding comprises a first region which has a low thermal conductivity, the first region being configured to prevent heat from the welding operation from reaching the inner pipeline.

3. The pipeline assembly according to claim 1, wherein the thermal shielding engages the inner pipeline.

4. The pipeline assembly according claim 1, wherein the thermal shielding is heat resistant at least in the proximity of the area of abutment of the outer pipe sections.

5. The pipeline assembly according claim 1, wherein the thermal shielding engages the outer pipeline in the area of abutment of the outer pipe sections.

6. The pipeline assembly according to claim 1, wherein the thermal shielding engages the outer pipeline in an area of engagement, wherein the area of engagement extends in the axial direction of the outer pipeline over a substantial distance on either side of the area of abutment of the outer pipe sections, at which distance there is substantially less heat during welding than in the area of abutment.

7. Pipeline assembly according to claim 1, wherein the thermal shielding comprises a first region and a second region, wherein the second region has a high thermal conductivity, and wherein the second region engages the area of abutment of the outer pipe sections.

8. The pipeline assembly according to claim 7, wherein the thermal shielding comprises a third region, which is substantially positioned between the first region and the second region, and wherein the third region is at least partially filled with a thermally insulating substance.

9. The pipeline assembly according claim 1, wherein the thermal shielding has the form of a substantial annular body.

10. The pipeline assembly according to claim 9, wherein the first region has a substantially annular form.

11. The pipeline assembly according to claim 7, wherein the second region has a substantially annular form.

12. The pipeline assembly according to claim 8, wherein the third region has a substantially annular form.

13. The pipeline according to claim 8, wherein the third region is a void, preferably filled with air.

14. The pipeline according to claim 8, wherein the third region is substantially manufactured from an insulating material, preferably cloth, the insulating material having a very low thermal conductivity.

15. The pipeline assembly according to claims 1, wherein the thermal shielding comprises at least two segments which in combination form an annular body.

16. The pipeline assembly according to claim 15, wherein the segments have substantially the same size.

17. The pipeline assembly according to claim 1, wherein the thermal shielding, in particular the first region, is at least in part manufactured from a ceramic material.

18. The pipeline assembly according to claim 1, wherein the thermal shielding, in particular the first region, is at least in part manufactured from a synthetic material.

19. The pipeline assembly according to claim 7, wherein the second region is manufactured from steel.

20. The pipeline assembly according to claim 11, wherein the second region is positioned substantially around the first region.

21. The pipeline assembly according to claim 1, wherein the thermal shielding extends over a length in the axial direction of the pipeline assembly, and wherein said length is substantially smaller than the length of an outer pipe section.

22. The pipeline assembly according to claim 1, further comprising first connection means for fixedly connecting the thermal shielding to the inner pipeline.

23. The pipeline assembly according to claim 1, further comprising second connection means for fixedly connecting the thermal shielding to the outer pipeline.

24. The pipeline assembly according to claim 1, wherein the inner pipeline is at least in part manufactured from a material, chosen from a group, consisting of: a synthetic material and a composite metal/synthetic material.

25. The pipeline assembly according to claim 1, comprising a plurality of joined pipe units, wherein a pipe unit comprises an outer pipe section, an inner pipe section and a thermal shielding, wherein the inner pipe section is arranged inside the outer pipe section, and wherein the thermal shielding is positioned between the inner pipe section and the outer pipe section, preferably proximal to one end of the outer pipe section.

26. The pipeline assembly according to claim 1, wherein the inner pipeline substantially engages with the outer pipeline outside the region of the thermal shielding, the inner pipeline forming an inner lining of the outer pipeline.

27. The pipeline assembly according to claim 1, wherein the inner pipeline has an outer diameter, and wherein the outer pipeline has an inner diameter, and wherein the outer diameter of the inner pipeline is between 1 and 50 mm smaller than the inner diameter of the outer pipeline, preferably between 10 and 30 mm smaller.

28. The pipeline assembly according to claim 1, wherein the thermal shielding has a substantial annular form, comprising a first end and a second end, wherein the thermal shielding has tapered first and second ends.

29. A thermal shielding for use in a pipeline assembly according to claim 1.

30. A pipe unit for use in a pipeline assembly according to claim 25.

31. A method for providing a pipeline assembly, the method comprising:
providing an inner pipeline;
providing a metal outer pipeline enclosing the inner pipeline by welding abutting outer pipe sections to each other in an area of abutment thereof; and
providing a thermal shielding between the inner pipeline and the outer pipeline, wherein the thermal shielding is configured to protect the inner pipeline from heat created by the welding operation in the area of abutment of the outer pipe sections, wherein the thermal shielding engages the outer pipeline.

32. The method according to claim 31, further comprising:
providing a first inner pipe section and a second inner pipe section, wherein the first inner pipe section defines the end of an inner pipeline;
providing a first outer pipe section and a second outer pipe section, wherein the first outer pipe section defines the end of an outer pipeline;
positioning the second inner pipe section in an abutting position relative to the first inner pipe section;
joining the first inner pipe section and the second inner pipe section;
providing the thermal shielding between the inner pipeline and the outer pipeline;
positioning the second outer pipe section in an abutting position relative to the first outer pipe section; and
welding the second outer pipe section to the first outer pipe section.

33. The method according to claim 31, wherein an outer pipe section, an inner pipe section and a thermal shielding are pre-assembled into a pipe unit, in which pre-assembly the inner pipe section is arranged inside the outer pipe section, and wherein the thermal shielding is arranged between the inner pipe section and the outer pipe section, proximal to one end of the outer pipe section, and wherein a plurality of pipe units are assembled into a pipeline assembly.

34. The method according to claim 31, wherein the inner pipeline is deformed to substantially engage with the outer pipeline outside the region of the thermal shielding, for providing an inner lining of the outer pipeline.

35. The method according to claim 34, wherein the pressure inside the inner pipeline is increased to a level which is higher than the pressure in the area between the inner pipeline and the outer pipeline.

36. The method according to claim 34, wherein the pressure in the inner pipeline is increased by filling the inner pipeline with a fluid, preferably water, for applying a hydrostatic pressure on the inner side of the inner pipeline.

37. The method according to claim 31, wherein the pipeline assembly is laid at sea.
